(19) United States
(12) Patent Application Publication
(10) Pub. No.: US 2025/0294476 A1
(43) Pub. Date: Sep. 18, 2025

(54) POWER HEADROOM REPORT TRIGGERING CONDITIONS IN FULL-DUPLEX OPERATION

(71) Applicant: QUALCOMM Incorporated, San Diego, CA (US)

(72) Inventors: Ahmed Attia ABOTABL, San Diego, CA (US); Abdelrahman Mohamed Ahmed Mohamed IBRAHIM, San Diego, CA (US); Muhammad Sayed Khairy ABDELGHAFFAR, San Jose, CA (US)

(21) Appl. No.: 18/814,003

(22) Filed: Aug. 23, 2024

Related U.S. Application Data
(63) Continuation of application No. 18/604,485, filed on Mar. 13, 2024.

(51) Int. Cl. H04W 52/36; H04L 5/14; H04W 72/231

(52) U.S. Cl. CPC H04W 52/365; H04L 5/14; H04W 72/231

(57) ABSTRACT

Certain aspects of the present disclosure provide techniques for triggering a power headroom report for full-duplex operation. A method for wireless communications by an apparatus includes enabling a first periodic timer to trigger transmission of a power headroom report (PHR) for full-duplex operation (FD-PHR) and sending the FD-PHR based on expiration of the first periodic timer.

### CROSS-REFERENCE TO RELATED APPLICATION

This application is a continuation of and claims priority to U.S. patent application Ser. No. 18/604,485 filed Mar. 13, 2024, which is incorporated herein by reference in its entirety.

### INTRODUCTION

### Field of the Disclosure

Aspects of the present disclosure relate to wireless communications, and more particularly, to techniques for triggering a power headroom report for full-duplex operation.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes enabling a first periodic timer to trigger transmission of a power headroom report (PHR) for full-duplex operation (FD-PHR); and sending the FD-PHR based on expiration of the first periodic timer.

Another aspect provides a method for wireless communications by an apparatus. The method includes enabling a periodic timer to trigger transmission of a power headroom report (PHR) for half-duplex operation (HD-PHR) and a FD-PHR; and sending the HD-PHR and the FD-PHR based on expiration of the periodic timer.

Another aspect provides a method for wireless communications by an apparatus. The method includes determining, for full-duplex operation, that at least one of a path loss or a change in a transmit power back-off requirement exceeds a predefined full-duplex transmission power factor parameter; and sending a FD-PHR based on at least one of a first determination or a second determination, wherein the first determination comprises a determination that the path loss or the change in the transmit power back-off requirement exceeds the predefined full-duplex transmission power factor parameter.

Another aspect provides a method for wireless communications by an apparatus. The method includes determining an occurrence of an event triggering a PHR; and sending a HD-PHR and a FD-PHR.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts illustrative signaling for PHR.

FIG. 6 depicts illustrative PHR configuration parameters.

FIG. 7 depicts illustrative Single Entry PHR medium access control control element (MAC-CE) and Multiple Entry PHR MAC-CE.

FIG. 8 depicts an illustrative PHR configuration.

FIG. 9 depicts another illustrative PHR configuration.

FIG. 10 depicts another illustrative PHR configuration.

FIG. 11 depicts another illustrative PHR configuration.

FIG. 12 depicts a method for wireless communications.

FIG. 13 depicts another method for wireless communications.

FIG. 14 depicts another method for wireless communications.

FIG. 15 depicts another method for wireless communications.

FIG. 16 depicts aspects of an example communications device.

### DETAILED DESCRIPTION

Aspects of the present disclosure provide apparatuses, methods, processing systems, and computer-readable mediums for triggering a power headroom report (PHR) for full-duplex operation. User equipment (UE) sends PHRs to a network entity (e.g., a base station) using, for example, medium access control control elements (MAC-CEs) transmitted on the physical uplink shared channel (PUSCH). The network entity can use these reports within its Packet Scheduler and Link Adaptation algorithms. The Packet Scheduler is responsible for identifying the number of Resource Blocks to be allocated to the PUSCH, whereas Link Adaptation is responsible for identifying the Modulation and Coding Scheme (MCS). In some instances, it may be necessary to restrict the number of allocated Resource Blocks or the allocated MCS if the UE is reporting a low power headroom (PH).

PHRs can also be used within other areas of Radio Resource Management. A network entity can use the reports to calculate the path loss towards the UE. These path loss results can then be used to enable or disable specific functionality. For example, a UE may be configured with uplink carrier aggregation when the path loss is low, and the configuration can be subsequently released if the path loss becomes high. That is, the UE may benefit from focusing its uplink transmit power across a single carrier rather than across multiple carriers when the path loss is high.

In some aspects, the UE may be configured for half-duplex (HD) operation and/or full-duplex (FD) operation. In half-duplex operation the UE may transmit with a first power and for full-duplex operation the UE may transmit with a different power. For example, for full-duplex operation the uplink power control includes additional considerations such as cross link interference (CLI) and self-interference (SI) at the network side. Thus, the uplink power control for half-duplex operation and full-duplex operation may be different. In some transmit instances, the uplink transmission power in full-duplex operation may be increased to address the self-interference at the network side. While in some transmit instances, the uplink transmission power in full-duplex operation may be reduced to reduce the CLI. Accordingly, full-duplex operation has different considerations and therefore have different PHRs compared to half-duplex operation.

In a full-duplex network, both half-duplex operation and full-duplex operation are allowed, but PHRs are only triggered for half-duplex operation, which results in deficient PHR information for full-duplex operation being transmitted to the network (e.g., the base station). Accordingly, there is a technical problem in that the network is systematically provided insufficient PHR information for full-duplex operation to further optimize network operations. In the event the network receives too little PHR information for full-duplex operation, the network may be unable to effectively manage the resources and allocate appropriate power levels to UEs. By knowing the power headroom of each UE, the network can make informed decisions regarding resource allocation and power control, ensuring efficient and reliable communication.

Additionally, a solution is needed so that the network is not overwhelmed with PHR information for full-duplex operation as too much PHR information has diminished returns for network performance, creates additional network reporting overhead, and wastes power at the UE through unnecessary PHR transmissions and at the network through unnecessary PHR receptions and processing.

Technical solutions to the aforementioned technical problem include establishing PHR triggering conditions and transmission configurations for full-duplex operation. Aspects described herein provide a timer configured to trigger a PHR for full-duplex operation that results in the correct amount of PHR information being sent to the network to improve network operations without wasting processing and power resources. Some aspects described herein configure two PHRs, one for each transmission type (e.g., half-duplex operation and full-duplex operation) to be triggered based on expiration of periodic timer. Some aspects described herein further establish a prohibit timer and/or a parameter related to a transmission power factor for full-duplex operation. Furthermore, UEs can be separately configured to transmit a PHR for half-duplex operation and full-duplex operation. For example, in some aspects, UEs can be configured to implement a new periodic timer to trigger transmission of a power headroom report for full-duplex operation.

The technical solutions described herein provide several technical benefits, including reducing overhead, reducing interference, and providing power savings at the network. Additionally, a further technical benefit includes improving power management of UEs by configuring the transmissions of PHR so that the UEs do not unnecessarily transmit PHRs and waste power.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

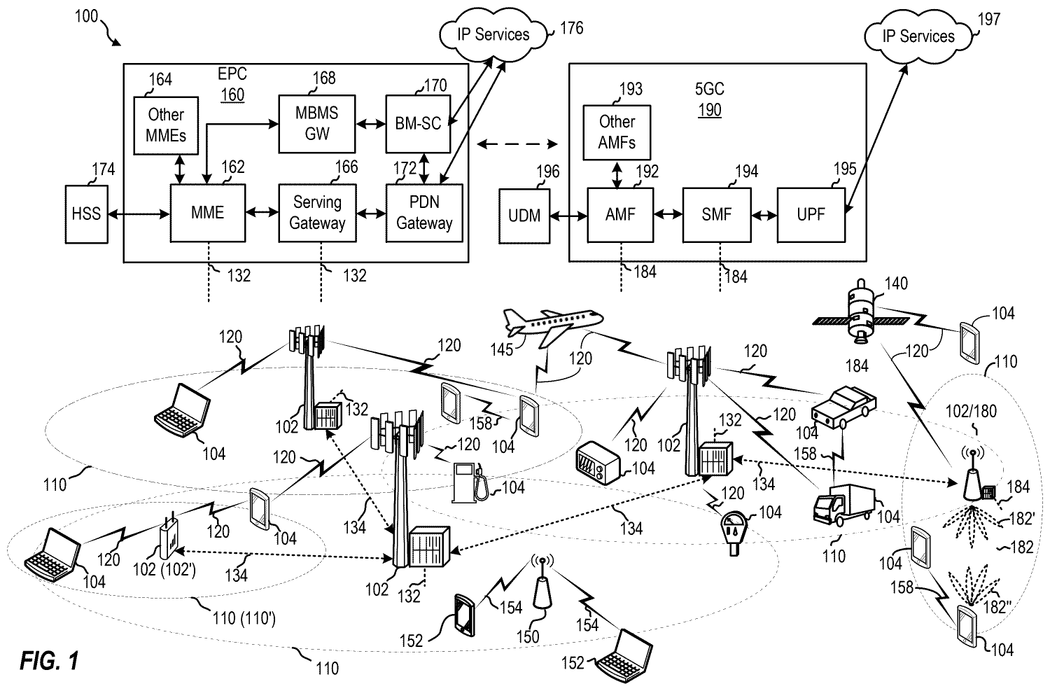

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and transporter, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

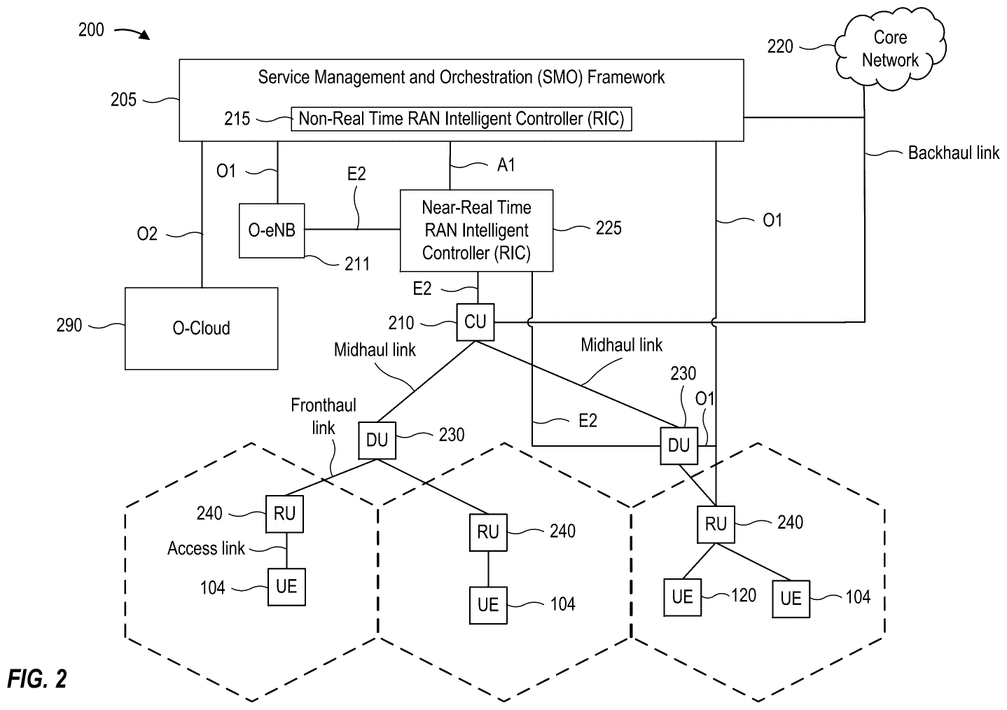

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

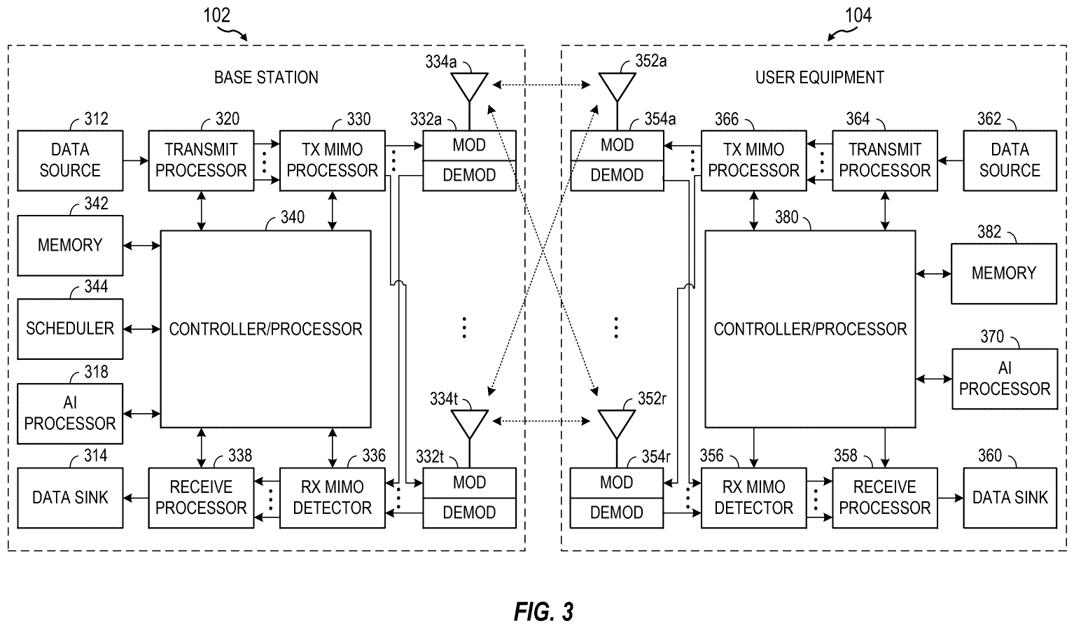

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

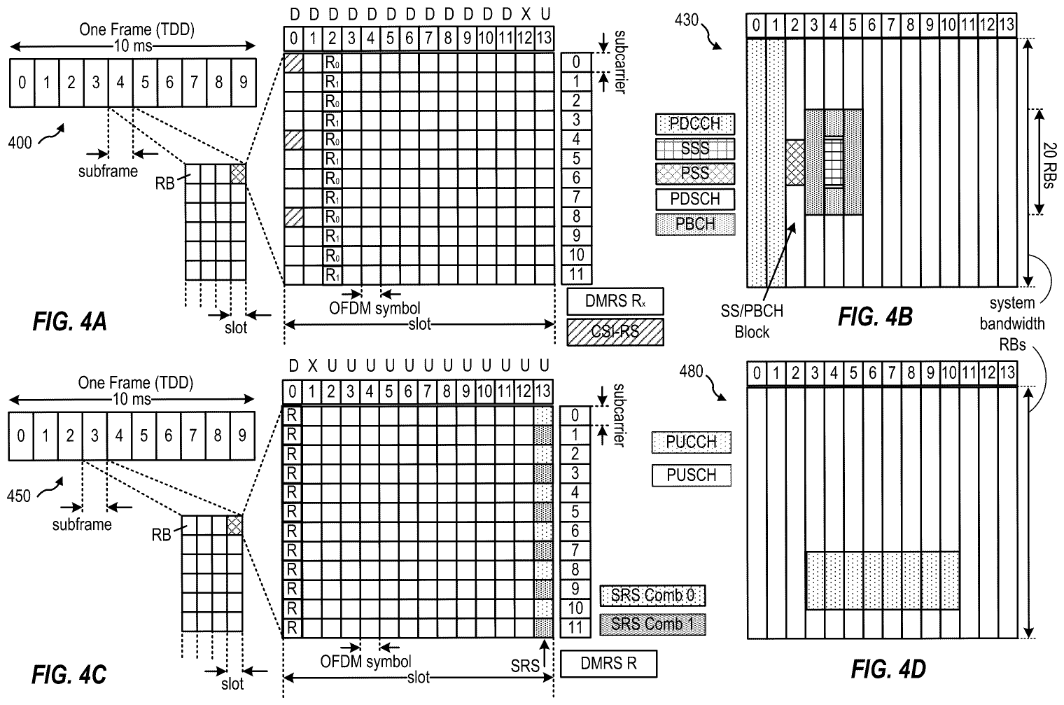

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology u, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Power Headroom Report

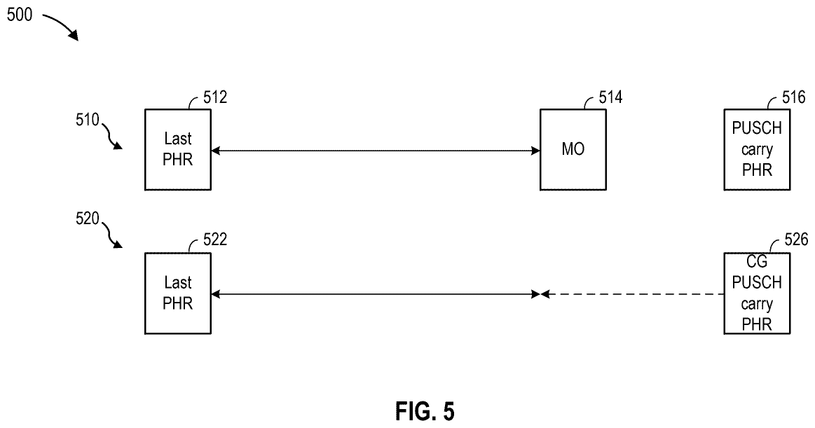

FIGS. 5-7 depict aspects of PHR transmission, configuration, and reporting. The following provides a brief background regarding PHR under current technical standards (e.g., 3GPP TS 38.321), which do not address full-duplex operation. As discussed above, a UE sends PHRs to a base station, for example, using MAC-CEs transmitted on the PUSCH. The PHR is a mechanism used by the UE to report available transmit power to the base station. PHRs are determined for multiple transmission types. For purposes of explanation two transmission types are discussed herein, “Type 1” and “Type 3.” A PH for “Type 1” quantifies the different between the nominal UE maximum transmit power and the PUSCH transmit power requirement. A PH for “Type 3” is based upon the Sounding Reference Signal (SRS) rather than the PUSCH. A PH for “Type 3” is included in the PHR if an actual SRS transmission is available while an actual PUSCH transmission is not available.

The PHR can be for an actual transmission or reference format based on higher layer signaling of configured grant and periodic/semi-persistent PDCCH monitoring occasion. FIG. 5 depicts illustrative signaling 500 for PHR. For example, signaling 510 depicts an instance of a monitoring occasion 514 where the UE receives a DCI scheduling a PUSCH that causes a PHR to be generated and sent. The PHR relies on the configuration from the last PHR 512. However, if there is no monitoring occasion such as in signaling 520, then the PHR relies on a configured grant (CG-PUSCH) 526 that defines some period of time since the last PHR 522 to be used for determining the PHR. The illustrative examples of PHR scheduling depicted in FIG. 5 depend on higher layer signaling of configured grant and periodic/semi-persistent sounding reference signal transmissions and downlink control information the UE received in a given period which depends on whether the PHR will be reported in PUSCH scheduled by a DCI or a CG-PUSCH.

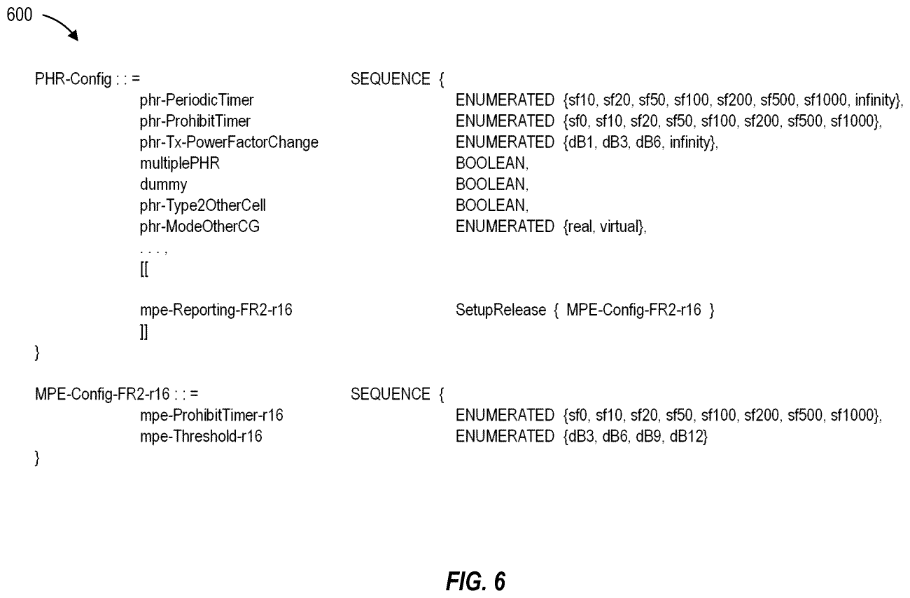

FIG. 6 depicts illustrative PHR configuration parameters. In some examples, a standard PHR is configured using the PHR-Config 600, for example, as depicted in FIG. 6. PHRs do not trigger Scheduling Requests. This means that PHRs are only sent when the UE has already been allocated PUSCH resources for another reasons, for example, to transfer uplink data. The phr-PeriodicTimer can be used to instruct the UE to send periodic PHRs for half-duplex operation, but not full-duplex operation. For example, configuring the phr-PeriodicTimer with a value of “infinity” disables periodic reporting. Otherwise, the period is defined in terms of subframes, for example, units of 1 millisecond (ms).

The phr-Tx-PowerFactorChange can be used to instruct the UE to send a PHR when the path loss has changed by more than the value of the parameter. Configuring a value of “infinity” disables path loss based reporting. Otherwise, path loss changes of 1, 3, or 6 dB can be used to trigger a PHR. A PHR can be also be triggered if the UE changes it's transmit power back-off requirement (Maximum Power Reduction (MPR)) by more than the value of phr-Tx-PowerFactorChange. The MPR may increase when a UE uses higher order modulation schemes or when using Resource Blocks towards the edge of the channel bandwidth. The MPR may also increase if there is a requirement to satisfy more stringent out-of-band emissions or spurious emissions.

The phr-ProhibitTimer is used to prevent the UE from sending PHRs too frequently. The prohibit timer is started after sending a report and subsequent reports triggered by path loss changes or power back-off changes cannot be sent until the timer has expired.

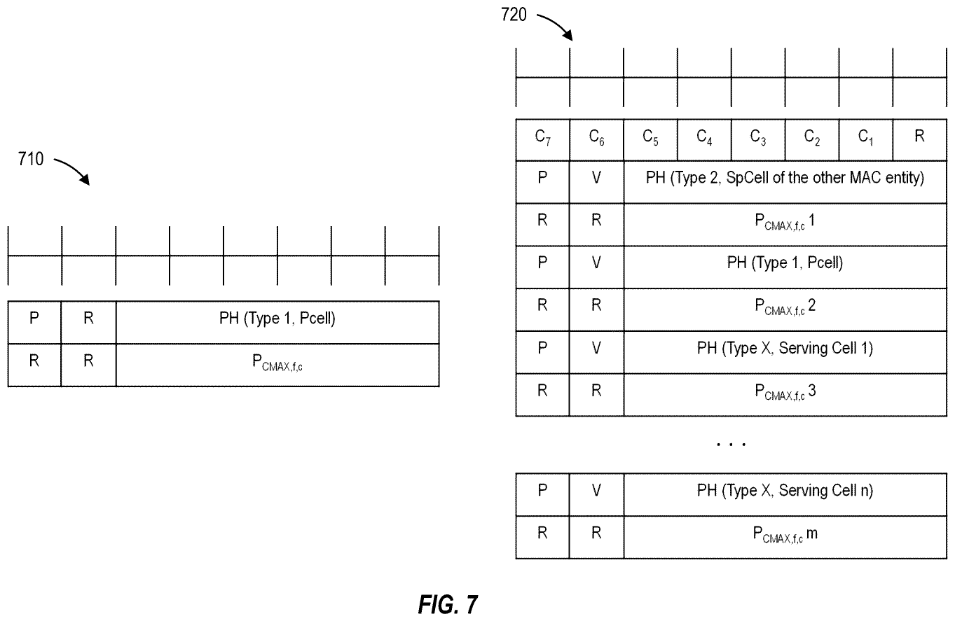

The multiplePHR information element instructs the UE to either use the “Single Entry” or “Multiple Entry” MAC-CE. FIG. 7 depicts illustrative example of a Single Entry PHR MAC-CE 710 and a Multiple Entry PHR MAC-CE 720. In the Single Entry PHR MAC-CE 710 the PHR value occupies a set of 6 bits providing a range from 0 to 63. These 64 signaled values are mapped onto PHR results defined in a look-up table.

A “Type 1” PHR quantifies the PH based on the difference between the nominal UE maximum transmit power (P_{CMAX,f,c} (i)) and the PUSCH transmit power requirement. As shown in the illustrative Single Entry PHR MAC-CE 710, another two bits (P and R) are provided for indications. The P field indicates whether or not the P_{CMAX,f,c} figure includes a power back-off due to a permitted MPR. The P field is set to “1” if the UE has applied a power-back-off. The R fields are reserved and are populated with “0,” by default.

The Single Entry PHR MAC-CE 710 report also includes the P_{CMAX,f,c} (i) value which was used to calculate the power headroom. This allows the base station to calculate the path loss, that is, the base station has knowledge of all other variables within the power control equation. The P_{CMAX,f,c} (i) value occupies a set of 6 bits within the report providing a range from 0 to 63. These 64 signaled values are mapped onto values defined in a look-up table.

The Multiple Entry PHR MAC-CE 720 starts with a set of seven flags (C1 to C7). The flags are used to indicate which serving cells have PHRs included within the MAC-CE. The V field indicates whether the PHR result is based upon a real transmission or a reference format (also known as a virtual transmission). It also indicates whether or not P_{CMAX,f,c} figure follows the PHR results, for example, a P_{CMAX,f,c} figure is only included when the PHR is based upon a real transmission.

As depicted in FIG. 7, according to current technical standards, a first PHR result within the Multiple Entry PHR MAC-CE 720 is a “Type 2” PHR and P_{CMAX,f,c} corresponding to the “Type 2” PHR value. The second PHR result within the Multiple Entry PHR MAC-CE 720 is a “Type 1” PHR and P_{CMAX,f,c} corresponding to the “Type 1” PHR value. Subsquent PHR results within the Multiple Entry PHR MAC-CE 720 is a “Type X” PHR and P_{CMAX,f,c} corresponding to the “Type X” PHR value, whereby the “Type X” may be either “Type 1” or “Type 3.”

### Aspects Related to Power Headroom Report Triggering Conditions for Full-Duplex Operation

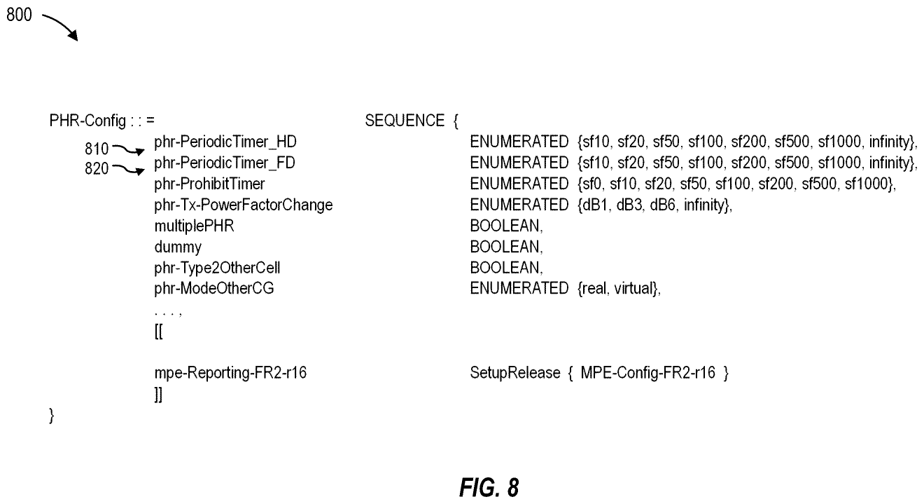

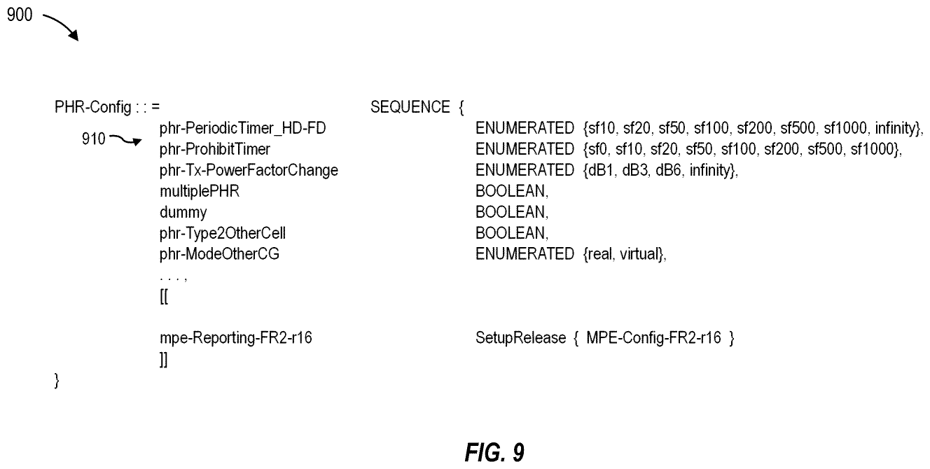

Various technical solutions for providing PHR triggers and transmission of PHR information for full-duplex operation will now be described with reference to FIGS. 8-12. FIG. 9 depicts an illustrative PHR configuration 900 corresponding to a technical solution for triggering a power headroom report for full-duplex operation. As depicted in FIG. 8, a new timer, defined as phr-PeriodicTimer_FD 820 is implemented. The new timer, phr-PeriodicTimer_FD 820, is configured along with the timer depicted as phr-PeriodicTimer_HD 810. The new timer, phr-PeriodicTimer_FD 820, is configured to trigger transmission of a power headroom report (PHR) for full-duplex operation (FD-PHR). This means that when the phr-PeriodicTimer_FD 820 is enabled and subsequently expires, a PHR is triggered for either an actual PUSCH transmission using the full-duplex operation or a reference full-duplex transmission. Similarly, when the phr-PeriodicTimer_HD 810 is enabled and subsequently expires, a PHR is triggered for either an actual PUSCH transmission using the half-duplex operation or a reference half-duplex operation.

Each of the two timers, the phr-PeriodicTimer_HD 810 and the phr-PeriodicTimer_FD 820 may be reset in response to a PHR being sent corresponding to the respective PHR for half-duplex operation or full-duplex operation. The reset may be caused by a triggering event nonexclusive of expiration of the periodic timer.

The UE may be configured to send the FD-PHR using a single entry PHR MAC-CE. The single entry PHR MAC-CE may include an indication the PHR corresponds to full-duplex operation. For example, a reserve field, R, as depicted in the Single Entry PHR MAC-CE 710 report of FIG. 7. For example, when the R value of the reserve field is set to “1” such that the indication of “1” may tell the network that the PH value in the PHR corresponds to full-duplex operation, whereas a “0” indicates that the PH value in the PHR corresponds to half-duplex operation, or vice-a-versa.

The UE may be configured to send the FD-PHR using the Multiple Entry PHR MAC-CE 720, for example, depicted in FIG. 7. Accordingly, instead of the Multiple Entry PHR MAC-CE 720 reporting PHR results for multiple serving cells, the Multiple Entry PHR MAC-CE 720 is configured to report PHR results for different operation modes, such as half-duplex and/or full-duplex. In some aspects, a first PHR result within the Multiple Entry PHR MAC-CE 720 is the FD-PHR. In some aspects, the first PHR result reported within the Multiple Entry PHR MAC-CE 720 is the FD-PHR and a subsequent PHR result reported within the Multiple Entry PHR MAC-CE 720 is a PHR for half-duplex operation. In other aspects, the first PHR result reported within the Multiple Entry PHR MAC-CE 720 is a PHR for half-duplex operation and a subsequent PHR result reported within the Multiple Entry PHR MAC-CE 720 is the FD-PHR.

The order of reporting the PHRs in the Multiple Entry PHR MAC-CE 720 may be, for example, pre-configured or RRC configured.

FIG. 9 depicts another illustrative PHR configuration 900 corresponding to a technical solution for triggering a power headroom report for full-duplex operation. As depicted in FIG. 9, the UE may be configured to enable a periodic timer, for example, phr-PeriodicTimer_HD-FD 910, to trigger transmission of a PHR for half-duplex operation and a PHR for full-duplex operation and send the PHR for half-duplex operation (HD-PHR) and the PHR for full-duplex operation (FD-PHR) based on expiration of the periodic timer.

The UE may be configured to send the HD-PHR and the FD-PHR using a sequence of single entry PHR MAC-CEs (e.g., the Single Entry PHR MAC-CE 710 depicted with reference to FIG. 7). For example, a first single entry PHR MAC-CE, which includes an indication the HD-PHR corresponds to half-duplex operation and a subsequent single entry PHR MAC-CE, which include an indication the FD-PHR corresponds to full-duplex operation may be used to send the HD-PHR and the FD-PHR. The PHR reported in the first single entry PHR MAC-CE may correspond to the FD-PHR and the subsequent single entry PHR MAC-CE may correspond to the HD-PHR.

The single entry PHR MAC-CE may include an indication the PHR corresponds to full-duplex operation. For example, a reserve field, R, as depicted in the Single Entry PHR MAC-CE 710 report of FIG. 7. For example, when the R value of the reserve field is set to “1” such that the indication of “1” may tell the network that the PH value in the PHR corresponds to full-duplex operation, whereas a “0” indicates that the PH value in the PHR corresponds to half-duplex operation, or vice-a-versa.

The UE may be configured to send the HD-PHR and the FD-PHR using the Multiple Entry PHR MAC-CE 720, for example, depicted in FIG. 7. Accordingly, instead of the Multiple Entry PHR MAC-CE 720 reporting PHR results for multiple serving cells, the Multiple Entry PHR MAC-CE 720 is configured to report PHR results for different operation modes, such as half-duplex and/or full-duplex. In some aspects, a first PHR result within the Multiple Entry PHR MAC-CE 720 is the FD-PHR. In some aspects, the first PHR result reported within the Multiple Entry PHR MAC-CE 720 is the FD-PHR and a subsequent PHR result reported within the Multiple Entry PHR MAC-CE 720 is the HD-PHR. In other aspects, the first PHR result reported within the Multiple Entry PHR MAC-CE 720 is the HD-PHR and a subsequent PHR result reported within the Multiple Entry PHR MAC-CE 720 is the FD-PHR.

The order of reporting the PHRs in the Multiple Entry PHR MAC-CE 720 may be, for example, pre-configured or RRC configured.

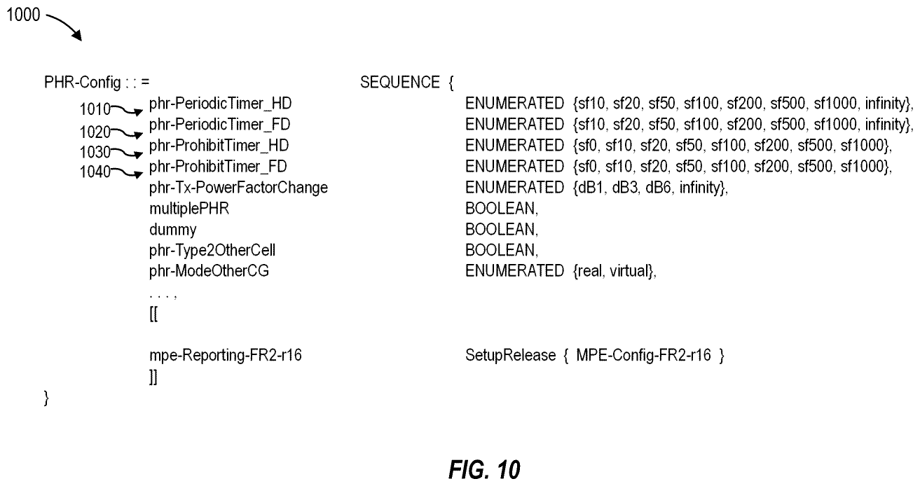

Independent of the aforementioned technical aspects or in conjunction with the aforementioned aspects, a prohibit timer corresponding to full-duplex operation and/or a parameter corresponding to power factor may be implemented with the UE to regulate the frequency of PHR reporting for full-duplex operations. FIG. 10 depicts another illustrative PHR configuration 1000 for a UE that includes a prohibit timer, phr-ProhibitTimer_FD 1020, corresponding to full-duplex operation and/or a power factor parameter, phr-Tx-PowerFactorChange_FD 1040, corresponding to full-duplex operation in addition to the half-duplex prohibit timer phr-ProhibitTimer_HD 1010 and the half-duplex power factor parameter, phr-Tx-PowerFactorChange_HD 1030. The PHR configuration 1000 enables the UE to determine, for full-duplex operation, that at least one of a path loss or a change in a transmit power back-off requirement exceeds a predefined full-duplex transmission power factor parameter, such as the phr-Tx-PowerFactorChange_FD 1040. When there is at least a change in path loss or a change in the transmit power back-off requirement that exceeds the predefined full-duplex transmission power factor parameter, the UE sends a PHR for the full-duplex operation.

The PHR configuration 1000 also enables the UE to determine, for half-duplex operation, that at least one of a path loss or a change in a transmit power back-off requirement exceeds a predefined half-duplex transmission power factor parameter, such as the phr-Tx-PowerFactorChange_HD 1030. When there is at least a change in path loss or a change in the transmit power back-off requirement that exceeds the predefined half-duplex transmission power factor parameter, the UE sends a PHR for the half-duplex operation.

However, in some aspects, the UE may be prohibited from sending a PHR for half-duplex operation and/or full-duplex operation too frequently based on the enablement of the phr-ProhibitTimer_HD 1010 and the phr-ProhibitTimer_FD 1020. That is, although a PHR may be triggered based on satisfaction of the phr-Tx-PowerFactorChange_HD 1030 or phr-Tx-PowerFactorChange_FD 1040 parameter, the UE may not send a corresponding PHR report until the phr-ProhibitTimer_HD 1010 and phr-ProhibitTimer_FD 1020 lapses. For example, a UE may be configured, based on the illustrative PHR configuration 1000, to enable a first prohibit timer, such as phr-ProhibitTimer_HD 1010, to prevent the one or more processors from causing the apparatus to send a PHR for half-duplex operation while the first prohibit timer is active, and to enable a second prohibit timer, such as phr-ProhibitTimer_FD 1020, to prevent the one or more processors from causing the apparatus to send the FD-PHR while the second prohibit timer is active.

For example, when the UE makes a first determination that at least one of a path loss or a change in a transmit power back-off requirement exceeds a predefined full-duplex transmission power factor parameter and a second determination that the second prohibit timer corresponding to full-duplex operation has expired, the UE sends the PHR for full-duplex operation. Similarly, when the UE makes a first determination that at least one of a path loss or a change in a transmit power back-off requirement exceeds a predefined half-duplex transmission power factor parameter and a second determination that the second prohibit timer corresponding to half-duplex operation has expired, the UE sends the PHR for half-duplex operation.

The UE may reset the first prohibit timer, for example the phr-ProhibitTimer_HD 1010, following sending the PHR for the half-duplex operation. Similarly, the UE may reset the second prohibit timer, for example the phr-ProhibitTimer_FD 1020, following sending the PHR for the full-duplex operation.

In some aspects, the PHR configuration may include a combination of each of the PHR configurations 800, 900, and 1000 described herein with reference to FIGS. 8-10.

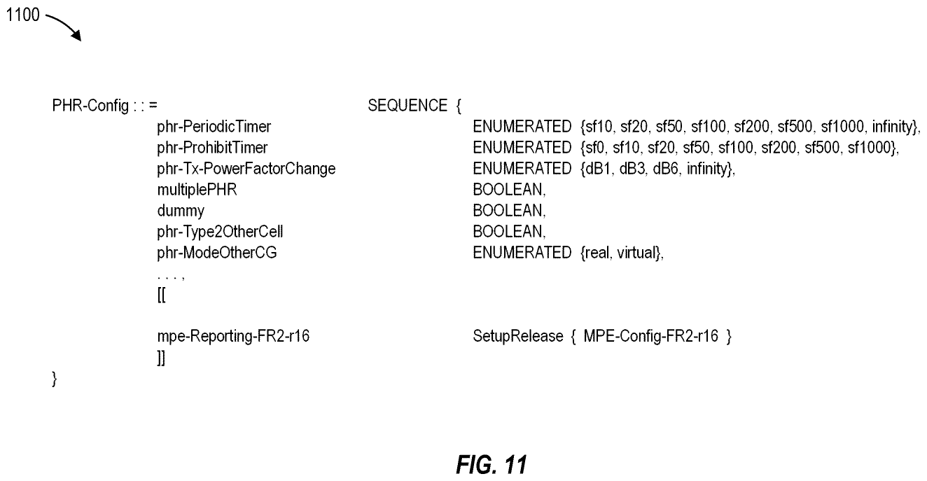

FIG. 11 depicts another illustrative PHR configuration 1100. With PHR configuration 1100, the UE is configured to generate two PHRs, for example, a PHR for half-duplex operation and a PHR for full-duplex operation for any PHR triggering event. Upon the UE determining an occurrence of an event triggering a PHR, the UE sends a PHR for half-duplex operation and a PHR for full-duplex operation.

The UE may be configured to send the PHR for half-duplex operation and a PHR for full-duplex operation using a sequence of single entry PHR MAC-CEs (e.g., the Single Entry PHR MAC-CE 710 depicted with reference to FIG. 7). For example, a first single entry PHR MAC-CE, which may include an indication the PHR for half-duplex operation corresponds to half-duplex operation and a subsequent single entry PHR MAC-CE, which may include an indication the PHR for full-duplex operation corresponds to full-duplex operation may be used to send the PHR for half-duplex operation and the PHR for full-duplex operation. The PHR reported in the first single entry PHR MAC-CE may correspond to the PHR for full-duplex operation and the subsequent single entry PHR MAC-CE may correspond to the PHR for half-duplex operation.

The single entry PHR MAC-CE may include an indication the PHR corresponds to full-duplex operation. For example, a reserve field, R, as depicted in the Single Entry PHR MAC-CE 710 report of FIG. 7. For example, when the R value of the reserve field is set to “1” the network may be indicated that the PH value in the PHR corresponds to full-duplex operation, whereas a “0” indicates that the PH value in the PHR corresponds to half-duplex operation, or vice-a-versa.

The UE may be configured to send the PHR for half-duplex operation and the PHR for full-duplex operation using the Multiple Entry PHR MAC-CE 720, for example, depicted in FIG. 7. Accordingly, instead of the Multiple Entry PHR MAC-CE 720 reporting PHR results for multiple serving cells, the Multiple Entry PHR MAC-CE 720 is configured to report PHR results for different operation modes, such as half-duplex and/or full-duplex. In some aspects, a first PHR result within the Multiple Entry PHR MAC-CE 720 is the PHR for full-duplex operation. In some aspects, the first PHR result reported within the Multiple Entry PHR MAC-CE 720 is the PHR for full-duplex operation and a subsequent PHR result reported within the Multiple Entry PHR MAC-CE 720 is the PHR for half-duplex operation. In other aspects, the first PHR result reported within the Multiple Entry PHR MAC-CE 720 is the PHR for half-duplex operation and a subsequent PHR result reported within the Multiple Entry PHR MAC-CE 720 is the PHR for full-duplex operation.

### Example Operations

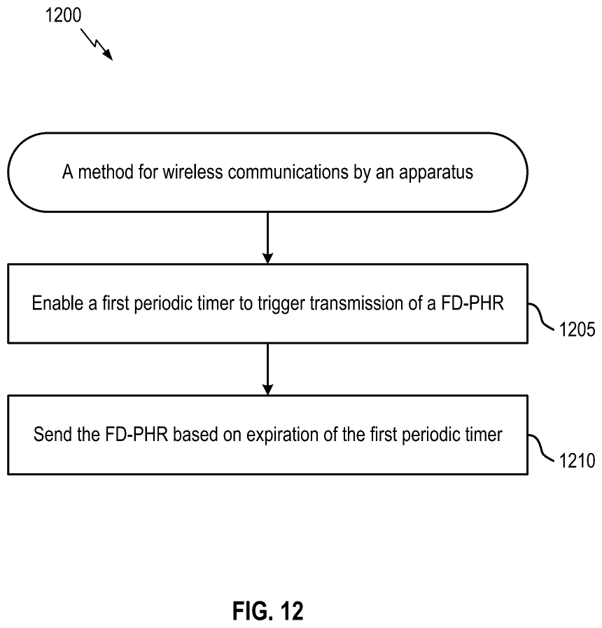

FIG. 12 shows a method 1200 for wireless communications by an apparatus, such as UE 104 of FIGS. 1 and 3.

Method 1200 begins at block 1205 with enabling a first periodic timer to trigger transmission of a FD-PHR.

Method 1200 then proceeds to block 1210 with sending the FD-PHR based on expiration of the first periodic timer.

In certain aspects, method 1200 further includes resetting the first periodic timer based on the one or more processors causing the apparatus to send the FD-PHR.

In certain aspects, method 1200 further includes enabling a second periodic timer to trigger transmission of a HD-PHR.

In certain aspects, method 1200 further includes sending the HD-PHR based on expiration of the second periodic timer.

In certain aspects, method 1200 further includes resetting the second periodic timer based on the one or more processors causing the apparatus to send the HD-PHR.

In certain aspects, the FD-PHR is sent using a single entry PHR MAC-CE, and the single entry PHR MAC-CE comprises an indication the PHR corresponds to full-duplex operation.

In certain aspects, a value of a reserve field of the single entry PHR MAC-CE is set as the indication.

In certain aspects, the FD-PHR is sent using a multiple entry PHR MAC-CE, and the multiple entry PHR MAC-CE comprises an indication that the multiple entry PHR MAC-CE includes one or more PHRs for a half-duplex operation or the full-duplex operation.

In certain aspects, a first PHR result within the multiple entry PHR MAC-CE is the FD-PHR.

In certain aspects, a first PHR result reported within the multiple entry PHR MAC-CE is the FD-PHR and a subsequent PHR result reported within the multiple entry PHR MAC-CE is a HD-PHR.

In certain aspects, a first PHR result reported within the multiple entry PHR MAC-CE is a HD-PHR and a subsequent PHR result reported within the multiple entry PHR MAC-CE is the FD-PHR.

In certain aspects, the FD-PHR is based on an actual PUSCH transmission using the full-duplex operation.

In certain aspects, the FD-PHR is based on a reference PUSCH transmission using the full-duplex operation.

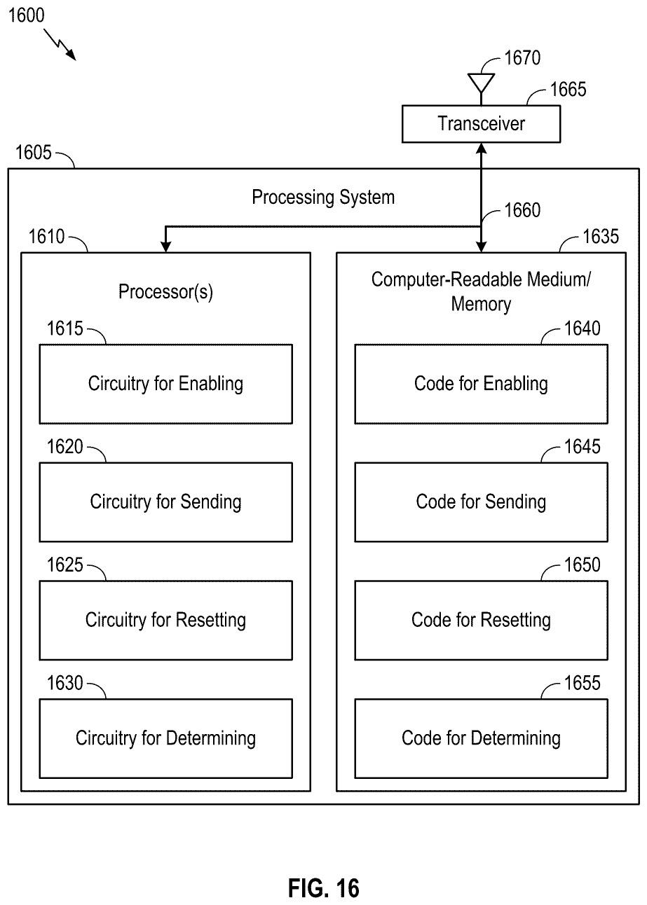

In certain aspects, method 1200, or any aspect related to it, may be performed by an apparatus, such as communications device 1600 of FIG. 16, which includes various components operable, configured, or adapted to perform the method 1200. Communications device 1600 is described below in further detail.

Note that FIG. 12 is just one example of a method, and other methods including fewer, additional, or alternative operations are possible consistent with this disclosure.

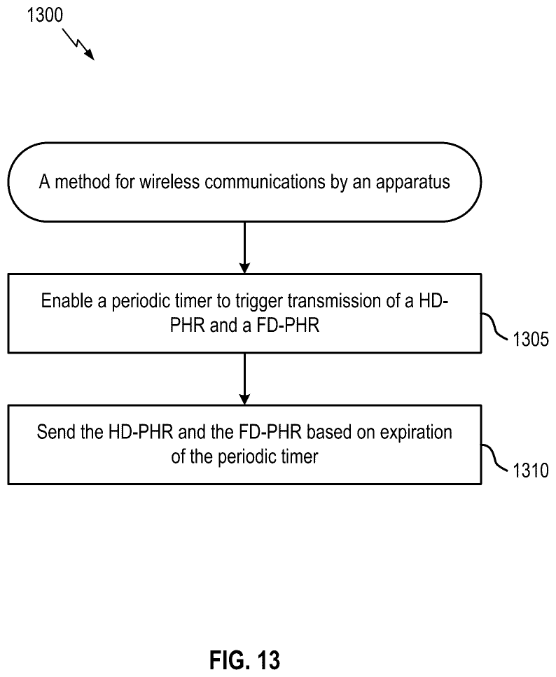

FIG. 13 shows a method 1300 for wireless communications by an apparatus, such as UE 104 of FIGS. 1 and 3.

Method 1300 begins at block 1305 with enabling a periodic timer to trigger transmission of a HD-PHR and a FD-PHR.

Method 1300 then proceeds to block 1310 with sending the HD-PHR and the FD-PHR based on expiration of the periodic timer.

In certain aspects, method 1300 further includes resetting the periodic timer based on the one or more processors causing the apparatus to send the HD-PHR and the FD-PHR.

In certain aspects, block 1310 includes: sending the HD-PHR using a first single entry PHR MAC-CE, wherein the first single entry PHR MAC-CE comprises an indication the HD-PHR corresponds to half-duplex operation; and sending the FD-PHR using a subsequent single entry PHR MAC-CE, wherein the subsequent single entry PHR MAC-CE comprises an indication the FD-PHR corresponds to full-duplex operation.

In certain aspects, block 1310 includes: sending the FD-PHR using a first single entry PHR MAC-CE, wherein the first single entry PHR MAC-CE comprises an indication the FD-PHR corresponds to full-duplex operation; and sending the HD-PHR using a subsequent single entry PHR MAC-CE, wherein the subsequent single entry PHR MAC-CE comprises an indication the HD-PHR corresponds to half-duplex operation.

In certain aspects, block 1310 includes sending the HD-PHR and the FD-PHR using a multiple entry PHR MAC-CE, wherein the multiple entry PHR MAC-CE comprises an indication that the multiple entry PHR MAC-CE includes one or more PHRs for half-duplex operation or full-duplex operation.

In certain aspects, a first PHR result reported within the multiple entry PHR MAC-CE is the FD-PHR and a subsequent PHR result reported within the multiple entry PHR MAC-CE is the HD-PHR.

In certain aspects, a first PHR result reported within the multiple entry PHR MAC-CE is the HD-PHR and a subsequent PHR result reported within the multiple entry PHR MAC-CE is the FD-PHR.

In certain aspects, the HD-PHR or the FD-PHR is based on an actual PUSCH transmission using the full-duplex operation.

In certain aspects, the HD-PHR or the FD-PHR is based on a reference PUSCH transmission using the full-duplex operation.

In certain aspects, method 1300, or any aspect related to it, may be performed by an apparatus, such as communications device 1600 of FIG. 16, which includes various components operable, configured, or adapted to perform the method 1300. Communications device 1600 is described below in further detail.

Note that FIG. 13 is just one example of a method, and other methods including fewer, additional, or alternative operations are possible consistent with this disclosure.

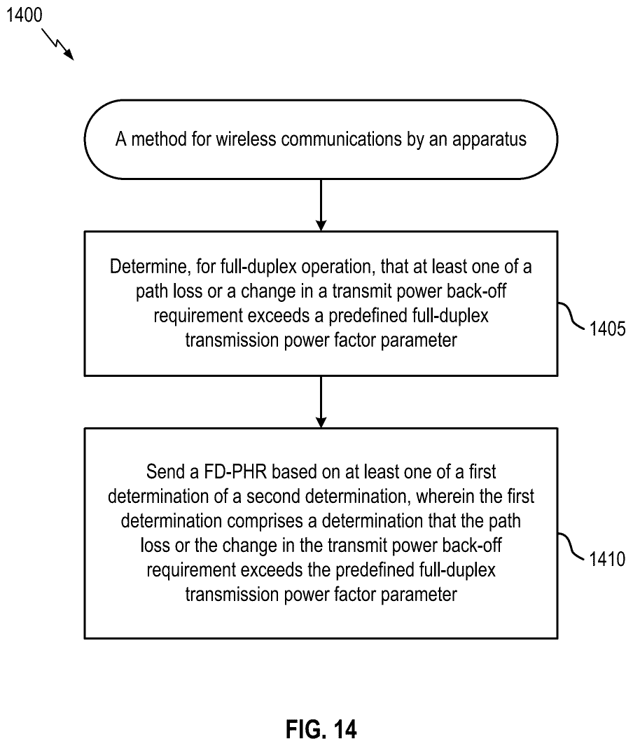

FIG. 14 shows a method 1400 for wireless communications by an apparatus, such as UE 104 of FIGS. 1 and 3.

Method 1400 begins at block 1405 with determining, for full-duplex operation, that at least one of a path loss or a change in a transmit power back-off requirement exceeds a predefined full-duplex transmission power factor parameter.

Method 1400 then proceeds to block 1410 with sending a FD-PHR based on at least one of a first determination or a second determination, wherein the first determination comprises a determination that the path loss or the change in the transmit power back-off requirement exceeds the predefined full-duplex transmission power factor parameter.

In certain aspects, method 1400 further includes enabling a first prohibit timer to prevent the one or more processors from causing the apparatus to send a HD-PHR while the first prohibit timer is active.

In certain aspects, method 1400 further includes enabling a second prohibit timer to prevent the one or more processors from causing the apparatus to send the FD-PHR while the second prohibit timer is active.

In certain aspects, method 1400 further includes determining that the second prohibit timer is expired.

In certain aspects, method 1400 further includes sending the FD-PHR based on the first determination and the second determination, wherein the second determination comprises the determination that the second prohibit timer is expired.

In certain aspects, method 1400 further includes resetting the second prohibit timer based on the one or more processors causing the apparatus to send the FD-PHR.

In certain aspects, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative operations are possible consistent with this disclosure.

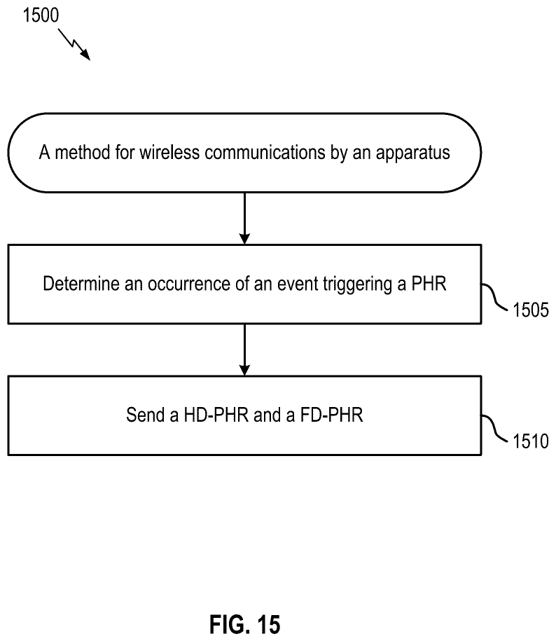

FIG. 15 shows a method 1500 for wireless communications by an apparatus, such as UE 104 of FIGS. 1 and 3.

Method 1500 begins at block 1505 with determining an occurrence of an event triggering a PHR.

Method 1500 then proceeds to block 1510 with sending a HD-PHR and a FD-PHR.

In certain aspects, block 1510 includes: sending the HD-PHR using a first single entry PHR MAC-CE, wherein the first single entry PHR MAC-CE comprises an indication the HD-PHR corresponds to half-duplex operation; and sending the FD-PHR using a subsequent single entry PHR MAC-CE, wherein the subsequent single entry PHR MAC-CE comprises an indication the FD-PHR corresponds to full-duplex operation.

In certain aspects, block 1510 includes: sending the FD-PHR using a first single entry PHR MAC-CE, wherein the first single entry PHR MAC-CE comprises an indication the FD-PHR corresponds to full-duplex operation; and sending the HD-PHR using a subsequent single entry PHR MAC-CE, wherein the subsequent single entry PHR MAC-CE comprises an indication the HD-PHR corresponds to half-duplex operation.

In certain aspects, block 1510 includes sending the HD-PHR and the FD-PHR using a multiple entry PHR MAC-CE, wherein the multiple entry PHR MAC-CE comprises an indication that the multiple entry PHR MAC-CE includes one or more PHRs for half-duplex operation or full-duplex operation.

In certain aspects, a first PHR result reported within the multiple entry PHR MAC-CE is the FD-PHR and a subsequent PHR result reported within the multiple entry PHR MAC-CE is the HD-PHR.

In certain aspects, a first PHR result reported within the multiple entry PHR MAC-CE is the HD-PHR and a subsequent PHR result reported within the multiple entry PHR MAC-CE is the FD-PHR.

In certain aspects, the HD-PHR or the FD-PHR is based on an actual PUSCH transmission using the full-duplex operation.

In certain aspects, the HD-PHR or the FD-PHR is based on a reference PUSCH transmission using the full-duplex operation.

In certain aspects, method 1500, or any aspect related to it, may be performed by an apparatus, such as communications device 1600 of FIG. 16, which includes various components operable, configured, or adapted to perform the method 1500. Communications device 1600 is described below in further detail.

Note that FIG. 15 is just one example of a method, and other methods including fewer, additional, or alternative operations are possible consistent with this disclosure.

### Example Communications Device

FIG. 16 depicts aspects of an example communications device 1600. In some aspects, communications device 1600 is a user equipment, such as UE 104 described above with respect to FIGS. 1 and 3.

The communications device 1600 includes a processing system 1605 coupled to a transceiver 1665 (e.g., a transmitter and/or a receiver). The transceiver 1665 is configured to transmit and receive signals for the communications device 1600 via an antenna 1670, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. The one or more processors 1610 are coupled to a computer-readable medium/memory 1635 via a bus 1660. In certain aspects, the computer-readable medium/memory 1635 is configured to store instructions (e.g., computer-executable code) that when executed by the one or more processors 1610, enable and cause the one or more processors 1610 to perform the method 1200 described with respect to FIG. 12, or any aspect related to it, including any operations described in relation to FIG. 12; the method 1300 described with respect to FIG. 13, or any aspect related to it, including any operations described in relation to FIG. 13; the method 1400 described with respect to FIG. 14, or any aspect related to it, including any operations described in relation to FIG. 14; and the method 1500 described with respect to FIG. 15, or any aspect related to it, including any operations described in relation to FIG. 15. Note that reference to a processor performing a function of communications device 1600 may include one or more processors performing that function of communications device 1600, such as in a distributed fashion.

In the depicted example, computer-readable medium/memory 1635 stores code for enabling 1640, code for sending 1645, code for resetting 1650, and code for determining 1655. Processing of the code 1640-1655 may enable and cause the communications device 1600 to perform the method 1200 described with respect to FIG. 12, or any aspect related to it; the method 1300 described with respect to FIG. 13, or any aspect related to it; the method 1400 described with respect to FIG. 14, or any aspect related to it; and the method 1500 described with respect to FIG. 15, or any aspect related to it.

The one or more processors 1610 include circuitry configured to implement (e.g., execute) the code stored in the computer-readable medium/memory 1635, including circuitry for enabling 1615, circuitry for sending 1620, circuitry for resetting 1625, and circuitry for determining 1630. Processing with circuitry 1615-1630 may enable and cause the communications device 1600 to perform the method 1200 described with respect to FIG. 12, or any aspect related to it; the method 1300 described with respect to FIG. 13, or any aspect related to it; the method 1400 described with respect to FIG. 14, or any aspect related to it; and the method 1500 described with respect to FIG. 15, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1665 and/or antenna 1670 of the communications device 1600 in FIG. 16, and/or one or more processors 1610 of the communications device 1600 in FIG. 16. Means for communicating, receiving or obtaining may include the transceivers 354, antenna(s) 352, receive processor 358, AI processor 370, and/or controller/processor 380 of the UE 104 illustrated in FIG. 3, transceiver 1665 and/or antenna 1670 of the communications device 1600 in FIG. 16, and/or one or more processors 1610 of the communications device 1600 in FIG. 16.

### Example Clauses

Implementation examples are described in the following numbered clauses:

Clause 1: A method for wireless communications by an apparatus comprising: enabling a first periodic timer to trigger transmission of a FD-PHR; and sending the FD-PHR based on expiration of the first periodic timer.

Clause 2: The method of Clause 1, further comprising resetting the first periodic timer based on the one or more processors causing the apparatus to send the FD-PHR.

Clause 3: The method of any one of Clauses 1-2, further comprising: enabling a second periodic timer to trigger transmission of a HD-PHR; and sending the HD-PHR based on expiration of the second periodic timer.

Clause 4: The method of Clause 3, further comprising resetting the second periodic timer based on the one or more processors causing the apparatus to send the HD-PHR.

Clause 5: The method of any one of Clauses 1-4, wherein: the FD-PHR is sent using a single entry PHR MAC-CE, and the single entry PHR MAC-CE comprises an indication the PHR corresponds to full-duplex operation.

Clause 6: The method of Clause 5, wherein a value of a reserve field of the single entry PHR MAC-CE is set as the indication.

Clause 7: The method of any one of Clauses 1-6, wherein: the FD-PHR is sent using a multiple entry PHR MAC-CE, and the multiple entry PHR MAC-CE comprises an indication that the multiple entry PHR MAC-CE includes one or more PHRs for a half-duplex operation or the full-duplex operation.

Clause 8: The method of Clause 7, wherein a first PHR result within the multiple entry PHR MAC-CE is the FD-PHR.

Clause 9: The method of Clause 7, wherein a first PHR result reported within the multiple entry PHR MAC-CE is the FD-PHR and a subsequent PHR result reported within the multiple entry PHR MAC-CE is a HD-PHR.

Clause 10: The method of Clause 7, wherein a first PHR result reported within the multiple entry PHR MAC-CE is a HD-PHR and a subsequent PHR result reported within the multiple entry PHR MAC-CE is the FD-PHR.

Clause 11: The method of any one of Clauses 1-10, wherein the FD-PHR is based on an actual PUSCH transmission using the full-duplex operation.

Clause 12: The method of any one of Clauses 1-11, wherein the FD-PHR is based on a reference PUSCH transmission using the full-duplex operation.

Clause 13: A method for wireless communications by an apparatus comprising: enabling a periodic timer to trigger transmission of a HD-PHR and a FD-PHR; and sending the HD-PHR and the FD-PHR based on expiration of the periodic timer.

Clause 14: The method of Clause 13, further comprising resetting the periodic timer based on the one or more processors causing the apparatus to send the HD-PHR and the FD-PHR.

Clause 15: The method of any one of Clauses 13-14, wherein sending the HD-PHR and the FD-PHR comprises: sending the HD-PHR using a first single entry PHR MAC-CE, wherein the first single entry PHR MAC-CE comprises an indication the HD-PHR corresponds to half-duplex operation; and sending the FD-PHR using a subsequent single entry PHR MAC-CE, wherein the subsequent single entry PHR MAC-CE comprises an indication the FD-PHR corresponds to full-duplex operation.

Clause 16: The method of any one of Clauses 13-15, wherein sending the HD-PHR and the FD-PHR comprises: sending the FD-PHR using a first single entry PHR MAC-CE, wherein the first single entry PHR MAC-CE comprises an indication the FD-PHR corresponds to full-duplex operation; and sending the HD-PHR using a subsequent single entry PHR MAC-CE, wherein the subsequent single entry PHR MAC-CE comprises an indication the HD-PHR corresponds to half-duplex operation.

Clause 17: The method of any one of Clauses 13-16, wherein sending the HD-PHR and the FD-PHR comprises sending the HD-PHR and the FD-PHR using a multiple entry PHR MAC-CE, wherein the multiple entry PHR MAC-CE comprises an indication that the multiple entry PHR MAC-CE includes one or more PHRs for half-duplex operation or full-duplex operation.

Clause 18: The method of Clause 17, wherein a first PHR result reported within the multiple entry PHR MAC-CE is the FD-PHR and a subsequent PHR result reported within the multiple entry PHR MAC-CE is the HD-PHR.

Clause 19: The method of Clause 17, wherein a first PHR result reported within the multiple entry PHR MAC-CE is the HD-PHR and a subsequent PHR result reported within the multiple entry PHR MAC-CE is the FD-PHR.

Clause 20: The method of any one of Clauses 13-19, wherein the HD-PHR or the FD-PHR is based on an actual PUSCH transmission using the full-duplex operation.

Clause 21: The method of any one of Clauses 13-20, wherein the HD-PHR or the FD-PHR is based on a reference PUSCH transmission using the full-duplex operation.

Clause 22: A method for wireless communications by an apparatus comprising: determining, for full-duplex operation, that at least one of a path loss or a change in a transmit power back-off requirement exceeds a predefined full-duplex transmission power factor parameter; and sending a FD-PHR based on at least one of a first determination or a second determination, wherein the first determination comprises a determination that the path loss or the change in the transmit power back-off requirement exceeds the predefined full-duplex transmission power factor parameter.

Clause 23: The method of Clause 22, further comprising: enabling a first prohibit timer to prevent the one or more processors from causing the apparatus to send a HD-PHR while the first prohibit timer is active; and enabling a second prohibit timer to prevent the one or more processors from causing the apparatus to send the FD-PHR while the second prohibit timer is active.

Clause 24: The method of Clause 23, further comprising: determining that the second prohibit timer is expired; and sending the FD-PHR based the first determination and the second determination, wherein the second determination comprises the determination that the second prohibit timer is expired.

Clause 25: The method of Clause 24, further comprising resetting the second prohibit timer based on the one or more processors causing the apparatus to send the FD-PHR.

Clause 26: A method for wireless communications by an apparatus comprising: determining an occurrence of an event triggering a PHR; and sending a HD-PHR and a FD-PHR.

Clause 27: The method of Clause 26, wherein sending the HD-PHR and the FD-PHR comprises: sending the HD-PHR using a first single entry PHR MAC-CE, wherein the first single entry PHR MAC-CE comprises an indication the HD-PHR corresponds to half-duplex operation; and sending the FD-PHR using a subsequent single entry PHR MAC-CE, wherein the subsequent single entry PHR MAC-CE comprises an indication the FD-PHR corresponds to full-duplex operation.

Clause 28: The method of any one of Clauses 26-27, wherein sending the HD-PHR and the FD-PHR comprises: sending the FD-PHR using a first single entry PHR MAC-CE, wherein the first single entry PHR MAC-CE comprises an indication the FD-PHR corresponds to full-duplex operation; and sending the HD-PHR using a subsequent single entry PHR MAC-CE, wherein the subsequent single entry PHR MAC-CE comprises an indication the HD-PHR corresponds to half-duplex operation.

Clause 29: The method of any one of Clauses 26-28, wherein sending the HD-PHR and the FD-PHR comprises sending the HD-PHR and the FD-PHR using a multiple entry PHR MAC-CE, wherein the multiple entry PHR MAC-CE comprises an indication that the multiple entry PHR MAC-CE includes one or more PHRs for half-duplex operation or full-duplex operation.

Clause 30: The method of Clause 29, wherein a first PHR result reported within the multiple entry PHR MAC-CE is the FD-PHR and a subsequent PHR result reported within the multiple entry PHR MAC-CE is the HD-PHR.

Clause 31: The method of Clause 29, wherein a first PHR result reported within the multiple entry PHR MAC-CE is the HD-PHR and a subsequent PHR result reported within the multiple entry PHR MAC-CE is the FD-PHR.

Clause 32: The method of any one of Clauses 26-31, wherein the HD-PHR or the FD-PHR is based on an actual PUSCH transmission using the full-duplex operation.

Clause 33: The method of any one of Clauses 26-32, wherein the HD-PHR or the FD-PHR is based on a reference PUSCH transmission using the full-duplex operation.

Clause 34: One or more apparatuses, comprising: one or more memories comprising executable instructions; and one or more processors configured to execute the executable instructions and cause the one or more apparatuses to perform a method in accordance with any one of Clauses 1-33.

Clause 35: One or more apparatuses, comprising: one or more memories; and one or more processors, coupled to the one or more memories, configured to cause the one or more apparatuses to perform a method in accordance with any one of Clauses 1-33.

Clause 36: One or more apparatuses, comprising: one or more memories; and one or more processors, coupled to the one or more memories, configured to perform a method in accordance with any one of Clauses 1-33.

Clause 37: One or more apparatuses, comprising means for performing a method in accordance with any one of Clauses 1-33.

Clause 38: One or more non-transitory computer-readable media comprising executable instructions that, when executed by one or more processors of one or more apparatuses, cause the one or more apparatuses to perform a method in accordance with any one of Clauses 1-33.

Clause 39: One or more computer program products embodied on one or more computer-readable storage media comprising code for performing a method in accordance with any one of Clauses 1-33.

Clause 40: A user equipment (UE), comprising: a processing system that includes processor circuitry and memory circuitry that stores code and is coupled with the processor circuitry, the processing system configured to cause the UE to perform a method in accordance with any one of Clauses 1-33.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising: one or more memories comprising processor-executable instructions; and one or more processors configured to execute the processor-executable instructions and cause the apparatus to:
determine, for full-duplex operation, that at least one of a change in a path loss or a change in a transmit power back-off requirement exceeds a predefined full-duplex transmission power factor parameter; and
send a power headroom report (PHR) for full-duplex operation (FD-PHR) based on at least one of a first determination or a second determination, wherein the first determination comprises a determination that the path loss or the change in the transmit power back-off requirement exceeds the predefined full-duplex transmission power factor parameter.

2. The apparatus of claim 1, wherein the one or more processors are configured to execute the processor-executable instructions and further cause the apparatus to:
enable a first prohibit timer to prevent the one or more processors from causing the apparatus to send a PHR for half-duplex operation (HD-PHR) while the first prohibit timer is active; and
enable a second prohibit timer to prevent the one or more processors from causing the apparatus to send the FD-PHR while the second prohibit timer is active.

3. The apparatus of claim 2, wherein the one or more processors are configured to execute the processor-executable instructions and further cause the apparatus to:
determine that the second prohibit timer is expired; and
send the FD-PHR based on the first determination and the second determination, wherein the second determination comprises the determination that the second prohibit timer is expired.

4. The apparatus of claim 3, wherein the one or more processors are configured to execute the processor-executable instructions and further cause the apparatus to reset the second prohibit timer based on the one or more processors configured to execute the processor-executable instructions and cause the apparatus to send the FD-PHR.

5. The apparatus of claim 1, wherein the predefined full-duplex transmission power factor parameter is at least one of 1 dB, 3 dB, or 6 dB.

6. The apparatus of claim 1, wherein:
to send the FD-PHR, the one or more processors are configured to execute the processor-executable instructions and cause the apparatus to use a single entry PHR medium access control control element (MAC-CE), and
the single entry PHR MAC-CE comprises an indication the PHR corresponds to full-duplex operation.

7. The apparatus of claim 6, wherein a value of a reserve field of the single entry PHR MAC-CE is configured as the indication.

8. The apparatus of claim 1, wherein:
to send the FD-PHR, the one or more processors are configured to execute the processor-executable instructions and cause the apparatus to use a multiple entry power headroom report (PHR) medium access control control element (MAC-CE), and
the multiple entry PHR MAC-CE comprises an indication that the multiple entry PHR MAC-CE includes one or more PHRs for a half-duplex operation or the full-duplex operation.

9. The apparatus of claim 8, wherein a first PHR result within the multiple entry PHR MAC-CE is the FD-PHR.

10. The apparatus of claim 8, wherein a first PHR result within the multiple entry PHR MAC-CE is the FD-PHR and a subsequent PHR result within the multiple entry PHR MAC-CE is a PHR for half-duplex operation (HD-PHR).

11. The apparatus of claim 8, wherein a first PHR result within the multiple entry PHR MAC-CE is a PHR for half-duplex operation (HD-PHR) and a subsequent PHR result within the multiple entry PHR MAC-CE is the FD-PHR.

12. A method for wireless communication by an apparatus comprising:
determining, for full-duplex operation, that at least one of a change in a path loss or a change in a transmit power back-off requirement exceeds a predefined full-duplex transmission power factor parameter; and
sending a power headroom report (PHR) for full-duplex operation (FD-PHR) based on at least one of a first determination or a second determination, wherein the first determination comprises a determination that the path loss or the change in the transmit power back-off requirement exceeds the predefined full-duplex transmission power factor parameter.

13. The method of claim 12, further comprising:
enabling a first prohibit timer to prevent the apparatus from sending a PHR for half-duplex operation HD-PHR while the first prohibit timer is active; and
enabling a second prohibit timer to prevent the apparatus from sending the FD-PHR while the second prohibit timer is active.

14. The method of claim 13, further comprising:
determining that the second prohibit timer is expired; and
sending the FD-PHR based the first determination and the second determination, wherein the second determination comprises the determination that the second prohibit timer is expired.

15. The method of claim 14, further comprising resetting the second prohibit timer based on the apparatus sending the FD-PHR.

16. The method of claim 12, wherein the predefined full-duplex transmission power factor parameter is at least one of 1 dB, 3 dB, or 6 dB.

17. The method of claim 12, wherein:
sending the FD-PHR uses a single entry PHR medium access control control element (MAC-CE), and
the single entry PHR MAC-CE comprises an indication the PHR corresponds to full-duplex operation.

18. The method of claim 17, wherein a value of a reserve field of the single entry PHR MAC-CE is configured as the indication.

19. The method of claim 12, wherein:
sending the FD-PHR uses a multiple entry power headroom report (PHR) medium access control control element (MAC-CE), and
the multiple entry PHR MAC-CE comprises an indication that the multiple entry PHR MAC-CE includes one or more PHRs for a half-duplex operation or the full-duplex operation.

20. The method of claim 19, wherein a first PHR result within the multiple entry PHR MAC-CE is the FD-PHR.
